(19) United States
(12) Patent Application Publication
(10) Pub. No.: US 2008/0131680 A1
(43) Pub. Date: Jun. 5, 2008

(54) ABSORBENT NON-SKID DROP CLOTH

(75) Inventors: Richard James Bliton, Greensboro, NC (US); Troy Raymond Buechler, Salisbury, NC (US); Samuel Mark Gillette, Burlington, NC (US); Philip Edward Harris, High Point, NC (US)

Correspondence Address: MYERS BIGEL SIBLEY & SAJOVEC, PO BOX 37428, RALEIGH, NC, 27627, US

(73) Assignee: Precision Fabrics Group, Inc.

(21) Appl. No.: 11/870,473

(22) Filed: Oct. 11, 2007

(51) Int. Cl. B32B 7/02; D04H 13/00

(52) U.S. Cl. 428/219; 442/414; 442/334

(57) ABSTRACT

An absorbent, non-skid drop cloth includes a lofted, non-woven fabric layer, and a non-skid barrier layer bonded to the non-woven fabric layer, wherein the barrier layer reduces slipping of the drop cloth on floors and other surfaces. The non-woven fabric layer has an absorbent capacity of greater than five hundred percent (500%) and a basis weight of less than five ounces per square yard (5 osy). The barrier layer includes polymeric film.

### FIELD OF THE APPLICATION

The present invention relates generally to protective covers and, more particularly, to drop cloths utilized to protect floors and other objects.

### BACKGROUND

Drop cloths are used where liquids, such as paint, stain, wall-paper paste, cleaners and the like are being applied to surfaces such as ceilings and walls. Conventional drop cloths are made from various materials including woven canvas-type materials, plastic sheeting, polymeric films, and laminates of various materials. Unfortunately, the woven fabric of conventional canvas drop cloths may allow liquids, such as paint, to penetrate and pass therethrough. Conventional plastic sheeting and polymeric film drop cloths are generally impervious to liquids. As such, liquids remain on the surface of these drop cloths and can come into contact with clothing, shoes and the like. In addition, conventional plastic sheeting and polymeric film drop cloths may have a tendency to slip during use and may not remain in a desired position.

### SUMMARY

In view of the above discussion, absorbent, non-skid drop cloths are provided. According to some embodiments, a drop cloth includes a lofted, non-woven fabric layer, and a non-skid barrier layer bonded to the non-woven fabric layer, wherein the barrier layer reduces slipping of the drop cloth on floors and other surfaces. In some embodiments, the non-woven fabric layer has an absorbent capacity of greater than five hundred percent (500%) and a basis weight of less than five ounces per square yard (5 osy). Exemplary non-woven fabrics include, but are not limited to, needlepunched non-woven fabrics, stitchbonded non-woven fabrics, spunlaced non-woven fabrics, spunbonded non-woven fabrics, powder-bonded non-woven fabrics, wet-laid non-woven fabrics, resin bond non-woven fabrics, air laid non-woven fabrics, flash spun non-woven fabrics, and thermal bonded non-woven fabrics.

In some embodiments, the barrier layer includes polymeric film. Exemplary films include, but are not limited to, olefins, urethanes, acrylics, polyesters, copolyesters, nylon, polyamide, copolyamide, and blends thereof. In some embodiments, the polymeric film is adhesively bonded to the non-woven fabric layer.

### DETAILED DESCRIPTION

The present invention now is described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s). It will be understood that the spatially relative terms are intended to encompass different orientations of a layer or panel in use or operation. For example, if a layer or panel is inverted, elements described as “under” or “beneath” other elements or features would then be oriented “over” the other elements or features. Thus, the exemplary term “under” can encompass both an orientation of “over” and “under.” A layer or panel may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

According to embodiments of the present invention, drop cloths that are slip resistant, that absorb liquids, such as paint, so that the liquids will not flow or spread excessively, and that have a barrier layer that prevents liquids from penetrating therethrough, are provided. As such, drop cloths, according to embodiments of the present invention, can reduce the potential for transfer of liquids to other surfaces, such as clothing and shoes.

According to some embodiments of the present invention, a drop cloth has a laminate structure formed from an absorbent, lofted non-woven fabric layer and a barrier layer with a non-skid outer surface. The lofted structure of the non-woven fabric is configured to absorb paint and other liquids, and the non-skid barrier film layer prevents the drop cloth from slipping on floors and other surfaces to which it is applied. The non-skid barrier layer additionally prevents liquids absorbed by the non-woven layer from penetrating therethrough to an underlying surface, such as a floor.

The non-woven layer can be prepared via any of the non-woven technologies known in the art including, but not limited to, needlepunched, stitchbonded, spunlaced, spunbonded, powder-bonded, wet-laid, resin bond, air laid, flash spun, and thermal bonded. Fabric constructions with good loft and abrasion resistance and “z-direction” fiber orientation, such as needlepunched, spunlaced, or air laid are particularly advantageous. As used herein, the term “z-direction” refers to a direction normal to the surface of a fabric layer. Accordingly, a “lofted” non-woven fabric layer includes fibers oriented outwardly along the z-direction.

In some embodiments of the present invention, the non-woven fabric layer is wettable by both solvent and water-based paints and has the ability to absorb and wick both solvent and water-based paints. As long as the orientation, loft, and wettability of the fibers in the non-woven layer are maintained, virtually any type of fiber or blend of fibers can be used. Moreover, fibers with hydrophobic or oleophobic surfaces may be utilized if treated with a wetting agent and/or blended with absorbent fibers.

The barrier layer of the laminate may be a coating, an extrusion laminate, or a laminated film. A film laminate utilizing any types of film-forming polymers may be utilized, as long as the strength and non-slip surface is maintained. Exemplary polymers for the barrier layer include, but are not limited to, olefins, urethanes, acrylics, polyesters, copolyesters, nylon, polyamide, copolyamide, as well as blends and coextruded layers of polymers. In some embodiments, a barrier layer may be ultrasonically or thermally bonded, and with or without an adhesive film or web.

Drop cloths, according to embodiments of the present invention, have numerous advantages over conventional drop cloths. For example, the lofted fabric structure presents a high degree of surface area for absorption of liquids. The non-woven fabric layer of a drop cloth, according to some embodiments of the present invention, may have an absorbent capacity greater than five hundred percent (500%). In addition, the surfactant treatment on the lofted fabric further enhances the absorbency of the fabric. The non-skid film prevents slippage of the drop cloth on surfaces. Also, drop cloths according to embodiments of the present invention are lighter in weight and easier to handle than conventional absorbent drop cloths.

### EXAMPLE #1

A 2.5 osy (ounce per square yard) unfinished needle-punched non-woven fabric from Performance Fabrics and Fibers was bonded using Huntsman RT-2730 APAO hot melt adhesive to a Pliant 3.0 mil co-extruded polyethylene film which has a non-skid outer layer

### EXAMPLE #2

A 2.5 osy needle-punched non-woven fabric from Performance Fabrics and Fibers was finished using a surfactant treatment and then laminated using Huntsman RT-2730 APAO hot melt adhesive to a Pliant 3.0 mil co-extruded polyethylene film with a non-skid outer layer. See data in Table 1 below.

TABLE 1
Physical Property Analysis
Competitive Drop Cloth Samples

| | | Polytuf | | | #12 Super | |
|---|---|---|---|---|---|---|
| | | Super | Heavy Duty | Gotcha | Premium | #2 Example |
| TEST PROPERTY | Butyl II | White | Contractor's | Covered | Weight | 3867-90753 |
| basis weight (oz./sq. yd.) | 6.92 | 2.99 | 3.21 | 1.94 | 13.20 | 4.30 |
| thickness (in.) | 0.028 | 0.009 | 0.015 | 0.013 | 0.044 | 0.030 |
| grab tensile - MD (lb.) | 58.5 | 94.8 | 19.5 | 17.7 | 277.7 | 39.3 |
| grab tensile - XD (lb.) | 35.4 | 99.8 | 11.7 | 12.9 | 133.0 | 43.6 |
| trap tear - MD (lb.) | 8.7 | 54.8 | 3.9 | 5.5 | 14.7 | 21.1 |
| trap tear - XD (lb.) | 18.2 | 55.6 | 9.9 | 8.3 | 45.7 | 18.1 |
| Absorbent Capacity (%) | 194.7 | 67.7 | 413.7 | 484.3 | 40.7 | 552.6 |
| Handle-O-Meter - MD | 105 | 36 | 43 | 18 | 210 | 59 |
| (grams-force) | | | | | | |
| Handle-O-Meter - XD | 50 | 54 | 20 | 8 | 123 | 48 |
| (grams-force) | | | | | | |
| Hydrohead (cm) | 58 | 114 | 73 | 75 | 18 | 166 |
| Coefficient of Friction | 0.484 | 0.461 | 0.615 | 0.556 | 0.813 | 0.763 |
| PFG “Paint Run” Test | 9.125 | 6.625 | 8.000 | 7.250 | 9.5+ | 4.125 |
| (in./3 min.) | | | | | | |

| TEST | METHOD |
|---|---|
| basis weight | Inda Standard Test 130.1-92 |
| Thickness | IST 120.2 |
| grab tensile - MD | IST 110.3-92 |
| grab tensile - XD | IST 110.3-92 |
| trap tear - MD | IST 100.2 |
| trap tear - XD | IST 100.2 |
| Absorbent Capacity (%) | IST 10.1 |
| Handle-O-Meter - MD | IST 90.3 |
| Handle-O-Meter - XD | IST 90.3 |
| Hydrohead | IST 80.6 |
| Coefficient of Friction | IST 140.0-82 |

### EXAMPLE #3

A 2.5 osy needle-punched non-woven fabric from Performance Fabrics and Fibers was finished using a surfactant treatment and then laminated using Huntsman RT-2730 APAO hot melt adhesive to a Pliant 2.0 mil co-extruded polyethylene film with a non-skid outer layer.

The foregoing is illustrative of the present invention and is not to be construed as limiting thereof. Although a few exemplary embodiments of this invention have been described and several examples provided, those skilled in the art will readily appreciate that many modifications are possible in the exemplary embodiments without materially departing from the novel teachings and advantages of this invention.

That which is claimed is:

1. A drop cloth, comprising:
a lofted, non-woven fabric layer; and
a non-skid barrier layer bonded to the non-woven fabric layer, wherein the barrier layer reduces slipping of the drop cloth on floors and other surfaces.

2. The drop cloth of claim 1, wherein the non-woven fabric layer has an absorbent capacity of greater than five hundred percent (500%).

3. The drop cloth of claim 1, wherein the drop cloth has a basis weight of less than five ounces per square yard (5 osy).

4. The drop cloth of claim 1, wherein the non-woven fabric layer is selected from the group consisting of: needlepunched non-woven fabric, stitchbonded non-woven fabric, spunlaced non-woven fabric, spunbonded non-woven fabric, powder-bonded non-woven fabric, wet-laid non-woven fabric, resin bond non-woven fabric, air laid non-woven fabric, flash spun non-woven fabric, and thermal bonded non-woven fabric.

5. The drop cloth of claim 1, wherein the barrier layer comprises polymeric film.

6. The drop cloth of claim 5, wherein the polymeric film is selected from the following group of polymers: olefins, urethanes, acrylics, polyesters, copolyesters, nylon, polyamide, copolyamide, and blends thereof.

7. The drop cloth of claim 1, wherein the polymeric film is adhesively bonded to the non-woven fabric layer.
